(19) United States
(12) Patent Application Publication
(10) Pub. No.: US 2008/0187564 A1
(43) Pub. Date: Aug. 7, 2008

(54) Pest-Control Member

(76) Inventors: Hidekazu Momiyama, Tochigi (JP); Toru Sako, Kanagawa (JP); Hitoshi Kobayashi, Kanagawa (JP)

Correspondence Address: CARR & FERRELL LLP, 2200 GENG ROAD, PALO ALTO, CA, 94303, US

(21) Appl. No.: 11/885,910

(22) PCT Filed: Mar. 7, 2006
(86) PCT No.: PCT/JP2006/304320

§ 371 Date: Sep. 7, 2007

(30) Foreign Application Priority Data
Mar. 7, 2005 (JP) 2005-062952

(51) Int. Cl. A01M 3/04; A01N 25/00

(52) U.S. Cl. 424/405; 43/136

(57) ABSTRACT

A pest-control member used to prevent equipment from pest damage by being attached to a target that becomes a migration path for pests entering the equipment, the pest-control member being configured so that it is entirely made of resin, its diameter is located perpendicular to the target when attached to the target, and it is formed in a shape to become an obstacle to the pests migrating along the target; the pest-control member including a target-receiving space for receiving the target and an opening for allowing the target to be placed in the target-receiving space; wherein when the target is placed via the opening into the target-receiving space, the pest-control member elastically changes its shape to close the opening and keeps its closed shape.

### TECHNICAL FIELD

The invention relates to a pest-control member used to prevent equipment from damage caused by pests, by being attached to a target that becomes a migration path for pests entering the equipment. Incidentally, the term “pests” used here means not only ants and cockroaches, but also any creatures such as spiders and centipedes that enter electric equipment and could adversely effect the operation of the electric equipment.

### BACKGROUND ART

Infestation of pests such as ants and cockroaches in equipment installed outdoors, such as automatic vending machines, may cause an electric system failure of the equipment or problems such as attachment of the pests to the products in the vending machines. These pests follow the legs of the equipment connected to the ground up and enter the equipment through gaps between the housing of the equipment and the legs.

The reasons for pests' flocking into equipment installed outdoors are unclear. However, the inside of equipment such as automatic vending machines and traffic signal control units is not influenced by rain or wind and is maintained at a constant temperature even in the winter. This might be one of the reasons. Once pests enter the equipment, they are not influenced by outside enemies and the environment inside the equipment can be comfortable and safe for the pests. Consequently, there is a possibility that damage caused by the pests may continue for a certain period of time and expand even further. Such pest damage is also caused to equipment installed indoors.

Various types of pest-control members have been suggested to prevent the above-described type of pest damage. For example, there are ring members containing an insecticide to be attached to the legs of automatic vending machines (Patent Document 1), and a cylindrical member containing a pest-repelling agent or insecticide for covering adjustable legs of automatic vending machines (Patent Document 2).
[Patent Document 1]. Japanese Patent Laid-Open (Kokai) Publication No. HEI 6-215241
[Patent Document 2] Japanese Utility Model Laid-Open (Kokai) Publication No. HEI 7-36273

### DISCLOSURE OF THE INVENTION

When attaching a conventional pest-repelling or insecticide pest-control member to a leg of existing equipment, a great burden is imposed on the person in charge of the work because the leg must be removed from the housing of the equipment or the person has to put his hand into a small gap between the housing and the ground to secure a fixing band for fixing the pest-control member to the leg.

In light of this, it is an object of the present invention to provide a pest-control member with less of a burden in terms of the attachment work. It is another object of the invention to provide a pest-control member that has a considerable effect of blocking the infestation of pests in equipment.

In order to achieve the above objects, the invention provides a pest-control member used to prevent equipment from pest damage by being attached to a target that becomes a migration path for pests entering the equipment, the pest-control member being configured so that it is entirely made of resin, its diameter is located perpendicular to the target when attached to the target, and it is formed in a shape to become an obstacle to the pests migrating along the target; the pest-control member including a target-receiving space for receiving the target, and an opening for allowing the target to be placed in the target-receiving space; wherein when the target is placed via the opening into the target-receiving space, the pest-control member elastically changes its shape to close the opening and keeps its closed shape.

Because of this configuration, the pest-control member can be easily attached to the target merely by being pushed in one direction towards a migration path for pests. Accordingly, the pest-control member can be easily attached even to a place where it has been difficult to attach conventional pest-control members.

Preferred embodiments of the present invention are as described below. It is preferable that a locking mechanism for keeping the closed shape is provided. As a result, the holding power required to keep the pest-control member according to the invention attached to the target can be further enhanced.

The pest-control member should preferably be configured so that before the target is placed in the target-receiving space, the locking mechanism is in an unlocked state and the shape of the pest-control member is maintained so that the opening connected to the target-receiving space exists; and in the process of placing the target in the target-receiving space, the pest-control member elastically changes its shape described above and the locking mechanism comes into a locked state, thereby completing the placement of the target in the target-receiving space. As a result, a sufficient opening can be secured to place the target in the target-receiving space without the need to force open the opening and, the target can be easily placed in the target-receiving space. When the pest-control member according to the invention is attached to the target, the shape of the pest-control member elastically changes, thereby locking the pest-control member. Accordingly, the pest-control member can be easily attached to the target without using any separate fixtures.

The resin should preferably contain a pest-control compound. As a result, the pest-control compound will keep away the pests entering equipment through the target and can thereby enhance the pest-control effect.

Also, the pest-control member should preferably be configured so that it is divided into a plurality of areas, the respective areas are connected via hinges to each other, the target-receiving space and the opening are formed between a first area and a second area, and the hinges elastically change their shapes to close an opening between the first area and the second area. As a result, a sufficient opening can be secured to place the target in the target-receiving space without the need to force open the opening, and the target can be easily placed in the target-receiving space. When the pest-control member according to the invention is attached to the target, the shape of the pest-control member elastically changes, thereby locking the pest-control member. Accordingly, the pest-control member can be easily attached to the target without using any separate fixtures.

It is preferable that the locking mechanism is composed of a first element and a second element that engage with each other; the first element and the second element are separated from each other before the target is placed in the target-receiving space; and when the first element and the second element are moved closer to each other in the process of placing the target in the target-receiving space, and when the placement of the target in the target-receiving space is then completed, the first element and the second element engage with each other to keep the opening closed. Because of this configuration, the pest-control member can be secured to the target using a one-touch action.

The pest-control member should preferably further include an outside wall extending radially from the outside surface of the pest-control member so that the outside wall forms an angle with the outside surface. Even if pests try to crawl over and go beyond the pest-control member, the outside wall will become an obstacle and can prevent the pest infestation.

It is preferable that an open end of the outside wall has a diameter equal to or larger than that of a base end of the outside wall. This configuration makes it more difficult for pests to enter equipment, and can further enhance the pest-control effect.

Moreover, the pest-control member should preferably further include flanges extending respectively from the edges of the first area and the second area that form the opening; and when the opening is closed, the flanges overlap each other tightly with no space between them in order to block pest infestation. Accordingly, even if any gap is made between the first area and the second area, the overlapping flanges will close the gap and can prevent pest infestation.

The pest-control member should preferably include a positioning protrusion for positioning the target in an area defining the target-receiving space. This configuration can guide the target to a position where a pressing force is applied most efficiently to the locking mechanism. As a result, the pest-control member can be attached properly to the target.

The locking mechanism should preferably further include a release part for releasing the engagement between the first element and the second element to make them disengaged. When the necessity to remove the pest-control member from the target arises, the above-described configuration makes it easy to remove the pest-control member.

The locking mechanism should preferably include a guide mechanism for accurately guiding the first element to the second element. Since the guide mechanism corrects any vertical or horizontal misalignment of the first element and the second element when having them engage with each other, the above-described configuration can perform the operation to engage the first element with the second element more accurately.

Also, the pest-repelling or insecticide pest-control member should preferably include an elastic member along the inside surface of the pest-control member that constitutes the target-receiving space. Even if the diameter of the migration path is different from that of the target-receiving space, the above-described configuration allows the elastic member to close any gap between the target and the pest-control member. Therefore, the pest infestation can be prevented more effectively.

The elastic member should preferably contain a pest-control compound. Because of this configuration, the pests entering through the migration path can be controlled more effectively.

The pest-control member according to the present invention can be attached to a target, which is a migration path for pests entering equipment, merely by applying an external force in one direction towards the target. Therefore, the pest-control member can be easily attached even to a place where it has been difficult to attach conventional pest-control members. As a result, pests trying to enter equipment or the like through migration paths can be controlled effectively.

### BRIEF DESCRIPTION OF THE DRAWINGS

FIG. 1 is a perspective view of a pest-control member 1 according to the first embodiment.

FIG. 2 is a front view of the pest-control member 1 according to the first embodiment.

FIG. 3 is a back view of the pest-control member 1 according to the first embodiment.

FIG. 4A is a front view of the pest-control member 1 in use according to the first embodiment, and FIG. 4B is a back view of the pest-control member 1 in use.

FIGS. 5A to 5C illustrate procedures for attaching the pest-control member 1 according to the first embodiment to a leg 200.

FIG. 6 is a front view of a pest-control member 2 not in use according to the second embodiment.

FIG. 7 is a front view of the pest-control member 2 in use according to the second embodiment.

FIG. 8 is a front view of a pest-control member 3 not in use according to the third embodiment.

FIG. 9 is a front view of a pest-control member 3 in use according to the third embodiment.

FIG. 10 is a front view of a pest-control member 4 not in use according to the fourth embodiment.

FIG. 11 is a front view of the pest-control member 4 in use according to the fourth embodiment.

FIG. 12 is a front view of a pest-control member 5 not in use according to the fifth embodiment.

FIGS. 13A to 13C illustrate how a pest-control member 6 with guides according to the sixth embodiment is attached to a target.

FIG. 14 is an enlarged view of part of the pest-control member 6 according to the sixth embodiment for explaining its locking mechanism.

FIGS. 15A and 15B are front views of a pest-control member 7 according to the seventh embodiment, FIG. 15A showing the pest-control member 7 not in use and FIG. 15B showing the pest-control member 7 in use.

FIG. 16 is an enlarged view of part of the pest-control member 7 according to the seventh embodiment for explaining its locking mechanism and elastic member 55.

FIG. 17 is a front view of a pest-control member 8 according to the eighth embodiment after it is attached to a target.

FIG. 18A is a diagram showing a pest-control member 9 according to the ninth embodiment before it is attached to a target, and FIG. 18B is a diagram showing the pest-control member 9 after it is attached to the target.

FIG. 19 is an enlarged view of part of the pest-control member 9 according to the ninth embodiment around its opening before it is attached to a target.

FIG. 20 is an enlarged view of part of the pest-control member 9 according to the ninth embodiment around its opening after it is attached to the target.

FIG. 21 is an enlarged view of part of the pest-control member 9 according to the ninth embodiment for explaining its locking mechanism and release part.

FIG. 22 is a diagram showing a pest-control member 100 according to the tenth embodiment when it is attached to a leg 20.

FIG. 23 is a diagram showing a pest-control member 110 according to the eleventh embodiment when it is attached to a leg 200.

### BEST MODE FOR IMPLEMENTING THE INVENTION

### First Embodiment

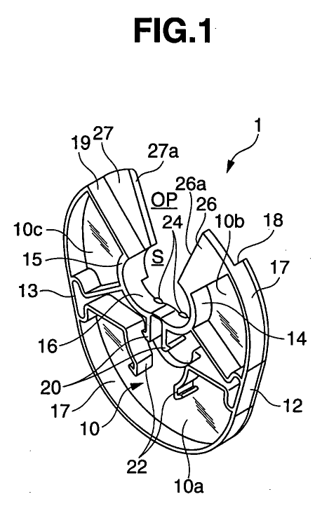

An embodiment of the present invention will be described below With reference to FIGS. 1 to 3. A pest-control member 1 is attached using a one-touch action to a leg of equipment that becomes a migration path for pests entering the equipment. The entire pest-control member is formed in a substantially circular shape. In this way, the pest-control member can realize a “pest barrier” that prevents pests following the leg toward the equipment from moving beyond the position where the pest-control member is installed. Examples of a target to which the pest-control member is attached include cords and pipes, in addition to legs.

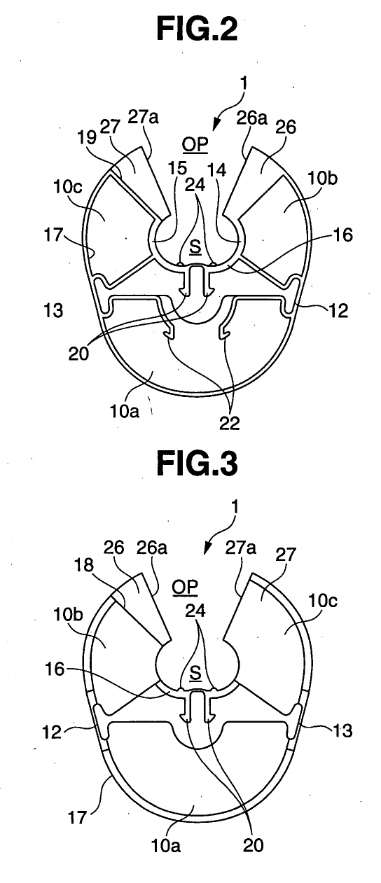

The embodiment will be described below in detail. FIG. 1 is a perspective view of the pest-control member 1. FIG. 2 is a front view of the pest-control member 1, and FIG. 3 is a back view of the pest-control member 1.

The pest-control member 1 can be obtained by integrally molding a resin. The resin may contain a pest-control compound. Examples of the pest-control compound include a pest-repelling agent or an insecticide. More specifically, examples of the pest-control compound include compounds having pest-control properties ( [symbol] , [symbol] ), compounds with pest-repelling properties ( [symbol] , [symbol] ), compounds with pest-extermination properties ( [symbol] ), compounds with pest antifeedant properties ( [symbol] , [symbol] ), and compounds with pest growth control properties ( [symbol] , [symbol] ). Possible specific examples are listed as follows: pyrethroid compounds ( [symbol] , [symbol] ); carbamate compounds ( [symbol] , [symbol] ); organic phosphorous compounds; and isomers, derivatives and analogues of the aforementioned compounds.

For the resin composing the pest-control member, at least one type of resin is selected from, for example, polyacetal resin and polyamide resin. The pest-control compound may be contained either in the entire pest-control member or part of the pest-control member. If the pest-control compound is contained only in part of the pest-control member, the part in direct contact with a leg or the like would be appropriate.

It is preferable that the resin contains a compound enabling controlled-release of the pest-control compound. As this type of compound, at least one type of compound can be selected from sulfonamide derivatives, sulfonate derivatives, carboxylic acid amide derivates, and carboxylate derivatives. Inclusion of the compound having controlled-release properties in the resin enables the effect of the pest-control compound to be maintained over a long period of time.

The case where the resin contains the pest-control compound and the compound enabling controlled-release of the pest-control compound was described above. However, a method for applying the pest-control compound and the compound enabling the controlled release of the pest-control compound is not limited to the above example, and the resin may be coated or impregnated with the compound having the controlled release properties.

As shown in FIGS. 1 to 3, the pest-control member 1 according to this embodiment has a pest barrier area 10 that constitutes a barrier for pests moving along a leg of equipment. Since the pest barrier area 10 is positioned perpendicular to the target such as a leg, the pests cannot go beyond the pest barrier area.

The pest barrier area 10 is composed of three areas 10a, 10b, and 10c. The pest barrier area 10a is connected via a hinge 12 to the pest barrier area 10b, and via a hinge 13 to the pest barrier area 10c. Opening OP (described later in detail) for allowing the leg to be placed in a target-receiving space S inside the pest-control member 1 is formed at one end of the pest-control member 1. If the leg is inserted through this opening into the target-receiving space S, the hinges 12, 13 change their shape to close the opening. Incidentally, FIG. 1 shows the pest-control member 1 not in use. Specifically, the hinges 12, 13 form the pest-control member 1 so that the opening OP to the target-receiving space S is maintained.

The outside peripheral edge of the pest-control member 1 around the pest barrier area 10 protrudes towards the front side to form a thin outside wall 17. The aforementioned hinges 13, 14, inside walls 14, 15 (described later), protruding strips 20 (described later), and an opening edge 19 are also formed. A combination of the outside wall 17 and the pest barrier area 10 serves as a barrier to pests.

As shown in FIGS. 1 to 3, the pest-control member 1 has a double-circular configuration. The outside wall 17 corresponds to an outside circle and the inside walls 14, 15 correspond to an inside circle. The inside wall 15 is an inside wall for the pest barrier area 10c, while the inside wall 14 is an inside wall for the pest barrier area 10b. The side ends of the inside wall 14, 15 adjacent to the pest barrier area 10a are connected to each other. The hinge 13 is formed into a substantially trumpet shape with its base end connected to the outside wall 17, and one tip of the opposite, forked end connected to the inside wall 15. The other tip of the forked end of the hinge 13 bends in an arc towards the outside wall of the pest barrier area 10a and ends in a hook shape, thereby forming a circular protrusion 22. The same can be said for the other hinge 12. A combination of the inside walls 14 and 15 constitutes a support 16 for supporting the pest barrier areas 10b and 10c as well as the pest barrier area 10a via the hinges 12, 13. A pair of protrusions 24 is placed adjacent to the pest barrier area 10a of the support 16 on the back side of the pest-control member 1. The positioning protrusions 24 serve to position the target, such as a leg or a cord, when placing it in the target-receiving space S; and after the target is placed in the target-receiving space S, the positioning protrusions 24 prevent the target from moving out of alignment in the target-receiving space S.

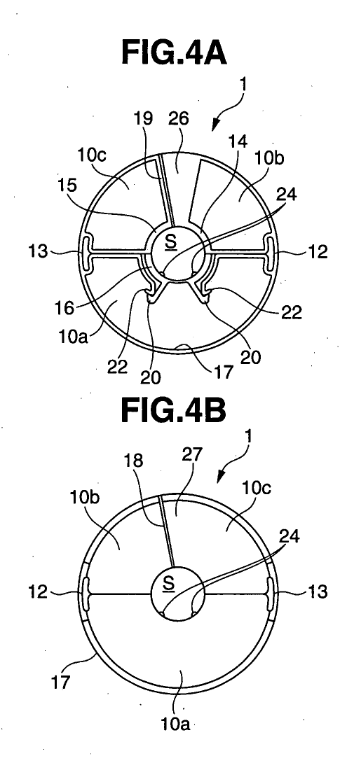

A pair of protruding strips 20 also extends from the end of the support 16 on the pest barrier area 10a side towards the pest barrier area 10a. The end of each protruding strip 20 is formed into a hook shape. When the target is placed in the target-receiving space S, the hinges 12, 13 elastically change their shape to close the opening OP. In this process, the support 16 changes its shape from an oval to a circle and the top ends of the protruding strips 20 spread out and approach the circular protrusions 22, and the hook-shaped ends of the protruding strips 20 ultimately engage with the hook-shaped ends of the circular protrusions 22 respectively, thereby keeping the opening OP closed. FIG. 4(A) shows a front view of the pest-control member 1 in this closed state. FIG. 4(B) is a back view of that state. Incidentally, because of the existence of the pair of positioning protrusions 24, the pressing force generated against the elastic force of the resin in the process of pushing the target into the target-receiving space S can be efficiently applied to the protruding strips 20.

As shown in FIGS. 1 to 3, a thin arc flange 26 protrudes from the opening edge 18 toward the pest barrier area 10c on the front side of the pest-control member 1. Similarly, a flange 27 protrudes from the opening edge 19 toward the pest barrier area 10b on the back side of the pest-control member 1. When the opening OP is closed, the flanges 26 and 27 overlap each other and the top ends of the flanges 26 and 27 come into contact with the opposite opening edges respectively, thereby defining the target-receiving space S and realizing the shape in which the opening OP is closed. In particular, since the flanges 26, 27 can overlap each other, no gap connecting the front side and the back side of the pest-control member 1 will remain in the opening OP when the opening OP is closed.

Also, it is possible to prevent the generation of any gap between the flanges by tapering the overlapping surfaces of the flanges so that the thickness of the flanges changes from their base ends at the opening edges 18, 19 towards their top ends 26a, 27a.

Next, the operation to use the pest-control member 1 will be described. A leg of an automatic vending machine is assumed as a target that becomes a migration path for pests entering the equipment, and to which the pest-control member 1 is applied. The leg has a base 202 and a cylindrical leg body 200.

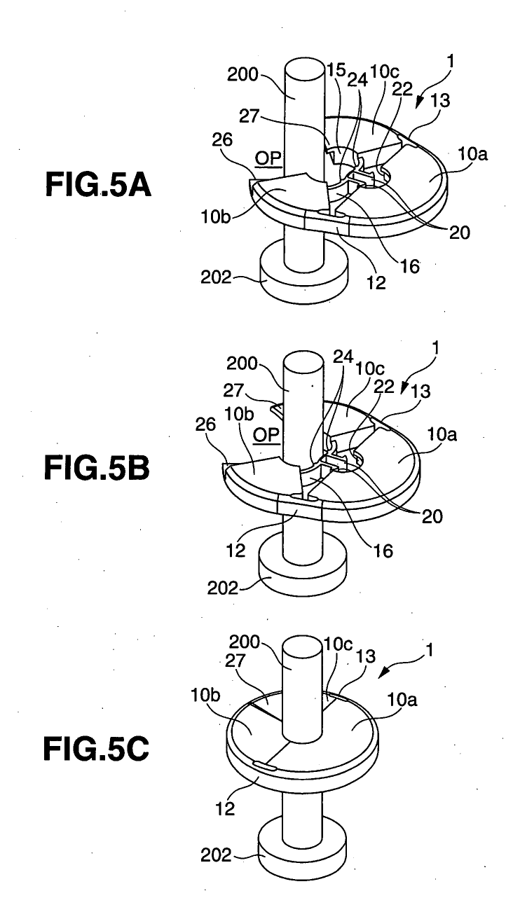

FIG. 5 illustrates procedures for attaching the pest-control member 1 to the leg 200. As shown in FIG. 5(A), the pest-control member 1 when not in use has the opening OP between the pest barrier area 10b and the pest barrier area 10c due to the elastic force of the hinges 12, 13. When the pest-control member 1 is pushed through this opening OP towards the leg 200, the opening OP guides the leg 200 to the target-receiving space S.

When the pest-control member 1 is further pushed to place the leg 200 into the target-receiving space S as shown in FIG. 5(B), the leg 200 comes into contact with the support 16. When the pest-control member 1 is still further pushed towards the leg 100, the hinges 12, 13 change their shape and the pest-control member 1 elastically changes its shape to close the opening OP as explained with reference to FIGS. 4(A) and 4(B). Then, this changed-shape state is maintained so that the pest-control member 1 can be attached around the leg 200 (FIG. 5(C)). As shown in FIG. 5, the pest-control member 1 has a thickness generally equal to that of its ring-shaped body and has the opening OP at its end. Accordingly, after the equipment is installed on the ground, the pest-control member 1 can be inserted into a small gap between the ground and the lower end of a front panel of the equipment and be attached to the leg 200 at the back of the gap.

### Second Embodiment

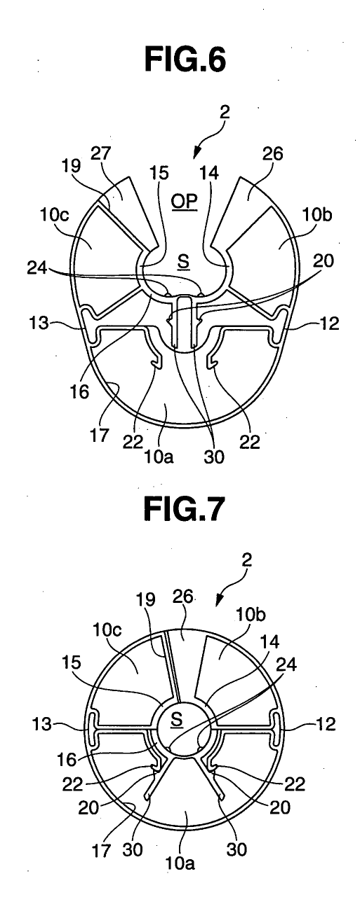

Next, a pest-control member 2 according to the second embodiment of the invention will be described. Both FIGS. 6 and 7 are front views of the pest-control member 2 according to the second embodiment. FIG. 6 shows the pest-control member 2 not in use according to the second embodiment, while FIG. 7 shows the pest-control member 2 in use according to the second embodiment. The pest-control member 2 according to the second embodiment is different from the pest-control member 1 according to the first embodiment shown in FIGS. 1 to 4 in that release parts 30 are formed at the top ends of the protruding strips 20.

These release parts 30 are intended to release and disengage the protruding strips 20 from the circular protrusions 22. In order to remove the pest-control member 2 according to the second embodiment from the target, the release parts 30 need to be pushed inwardly with fingers or the tip of a screwdriver. As a result, the legs of the release parts 30 are closed, so that the protruding strips 20 are released from the circular protrusions. 22; and the force applied by the hinges 12 and 13 causes the pest-control member 2 to return from the state shown in FIG. 7 to the state shown in FIG. 6. Subsequently, the opening OP is formed and, therefore, the target can be released from the target-receiving space S through the opening OP.

### Third Embodiment

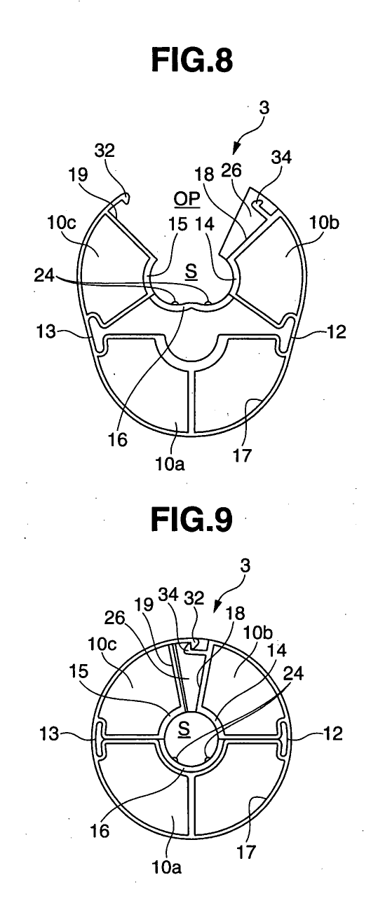

FIGS. 8 and 9 show a pest-control member 3 according to the third embodiment. Both FIGS. 8 and 9 are front views of the pest-control member 3 according to the third embodiment. FIG. 8 shows the pest-control member 3 not in use according to the third embodiment, while FIG. 9 shows the pest-control member 3 in use according to the third embodiment.

The pest-control member 3 according to the third embodiment is different from the pest-control member 1 according to the first embodiment shown in FIGS. 1 to 4 in that protruding strips 32 and circular protrusions 34 that constitute a locking mechanism protrude from the opening edges 18, 19 of the pest barrier areas 10b and 10c and the flange 26 is formed only at one opening edge 18. The pest-control member 3 having the above-described configuration can have a similar effect to that of the pest-control member 1 according to the first embodiment.

### Fourth Embodiment

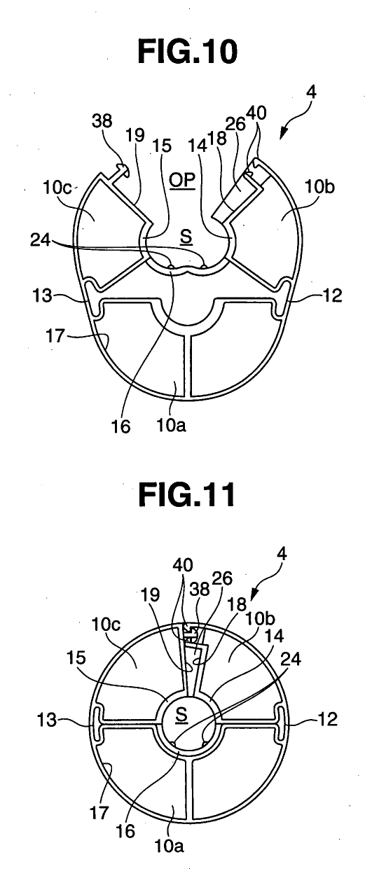

FIGS. 10 and 11 show a pest-control member 4 according to the fourth embodiment. Both FIGS. 10 and 11 are front views of the pest-control member 4 according to the fourth embodiment. FIG. 10 shows the pest-control member 4 not in use according to the fourth embodiment, while FIG. 11 shows the pest-control member 4 in use according to the fourth embodiment.

The pest-control member 4 according to the fourth embodiment is different from the pest-control member 3 according to the third embodiment shown in FIGS. 8 and 9 in that the shapes of a protruding strip 38 and engaging protrusions 40 for engaging with the protruding strip 38, that protrude respectively from the opening edges 18 and 19 of the pest barrier areas 10b and 10c and constitute a locking mechanism, are of a double-hook type.

Since the pest-control member 4 according to the fourth embodiment is a double-hook type, the engagement strength can be enhanced. As a result, it is possible to make it more difficult to remove the pest-control member 4 from the target.

### Fifth Embodiment

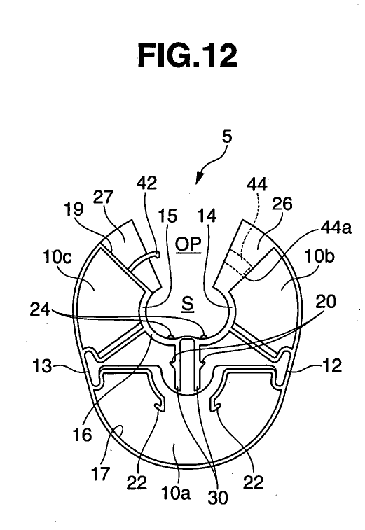

FIG. 12 shows a pest-control member 5 according to the fifth embodiment of the invention. FIG. 12 is a front view of the pest-control member 5 according to the fifth embodiment. The pest-control member 5 according to the fifth embodiment is different from the pest-control member 2 according to the second embodiment shown in FIGS. 6 and 7 in that a protruding strip 42—a first element of a locking mechanism—protrudes from the opening edge 19 of the pest barrier area 10c and an engaging groove 44—a second element of the locking mechanism—is embedded in the flange extending from the pest barrier area 10b.

When the opening OP is closed in the above-described configuration, the engaging claw 42 is inserted into the engaging groove 44 and the folded portion of the engaging claw 42 at its top end engages with the end of the engaging groove 44 and, therefore, this locking mechanism together with the other locking mechanism (the protruding strips 20 and the circular protrusions 22) maintains the pest-control member 5 according to the fifth embodiment in the closed state. As a result, the pest-control member 5 can be held at the target more firmly.

### Sixth Embodiment

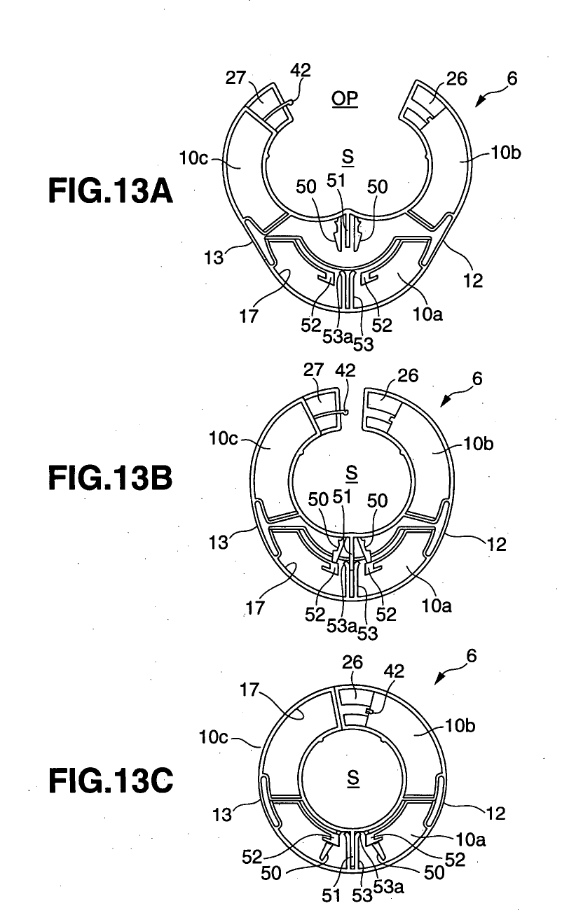

FIGS. 13(A) to 13(C) show a pest-control member 6 according to the sixth embodiment of the invention. FIGS. 13(A) to 13(C) are front views of the pest-control member 6 according to the sixth embodiment and illustrate how the pest-control member 6 with guides according to the sixth embodiment is attached to a target (not shown).

The pest-control member 6 according to the sixth embodiment is different from the pest-control members 1 to 5 according to other embodiments in that it has a guide mechanism for accurately guiding a first element of a locking mechanism (protruding strips 50) to a second element thereof (circular protrusions 52). Incidentally, the pest-control member 6 according to the sixth embodiment is also different from the pest-control members 1 to 5 according to other embodiments in that pest barrier areas (11a, 11b, and 11c) are molded to form a larger target-receiving space S than that in any of the pest-control members 1 to 5.

The guide mechanism is intended to correct any misalignment of the first element when inserted into the second element, and to accurately guide the first element to the second element by providing protrusions or walls on the second element to support the first element from its both sides. The shape of the guide mechanism can change corresponding to the shapes of the first element and the second element.

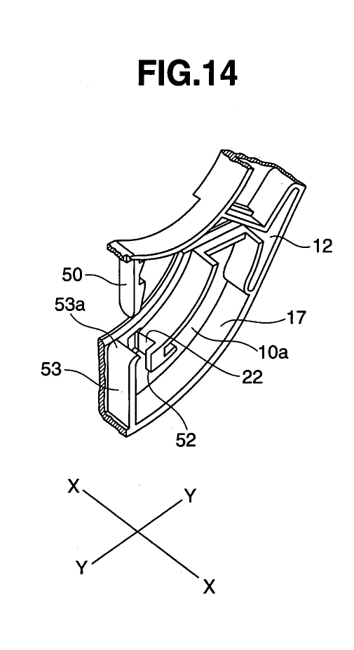

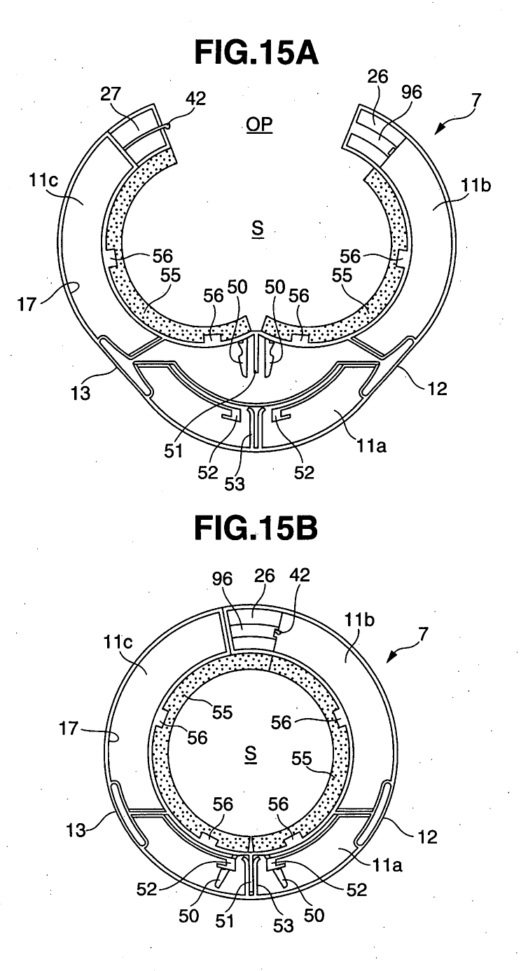

FIG. 14 is a fragmentary enlarged view of an example of the guide mechanism. In a case of the protruding strip 50, whose one surface is raised and recessed in the Y-Y direction as shown in FIG. 14, it is preferable that a guide 52 for preventing misalignment in the X-X direction in the drawing protrudes from the end of the circular protrusion 22.

As another example of the guide mechanism, a rod protrusion 51 having a flat surface with no raised or recessed area, and support walls 53 for supporting the rod protrusion 51 from both sides and preventing any misalignment of the rod protrusion 51 in the Y-Y direction can be formed as shown in FIG. 13. Also, if the ends 53a of the support walls 53 where the rod protrusion 51 is inserted are formed at a specified angle so that they spread open outwardly, even if the insertion position of the rod protrusion 51 is misaligned in the Y-Y direction, it can be corrected to the right insertion position.

### Seventh Embodiment

FIGS. 15(A) and 15(B) show a pest-control member 7 according to the seventh embodiment of the invention. FIGS. 15(A) and 15(B) are front views of the pest-control member 7 according to the seventh embodiment. FIG. 15A shows the pest-control member 7 not in use according to the seventh embodiment, while FIG. 15B shows the pest-control member 7 in use according to the seventh embodiment. As shown in FIGS. 15(A) and 15(B), the pest-control member 7 according to the seventh embodiment is different from the pest-control member 6 according to the sixth embodiment shown in FIGS. 13(A) to 13(C) in that an elastic member 55 is placed along the inside surface constituting the target-receiving space S.

The material used for the elastic member 55 is one that can change its shape corresponding to the shape of the target when the pest-control member according to this embodiment is attached to the target that becomes a migration path for pests. Specific examples of the elastic member 55 can include sponge, rubber, and expanded polystyrene.

The elastic member 55 can be molded and used without any modification on the inside surface of the pest-control member 7. However, the aforementioned pest-control compound may be applied to the elastic member 55 by means of inclusion, coating, or impregnation. As a result, the pest-control effect can be given to the elastic member 55, and as a result the pest-control member 7 according to the seventh embodiment can exert its effect more significantly.

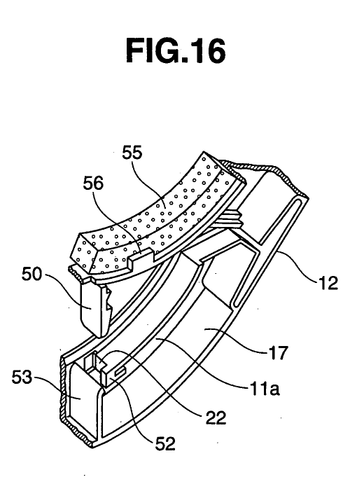

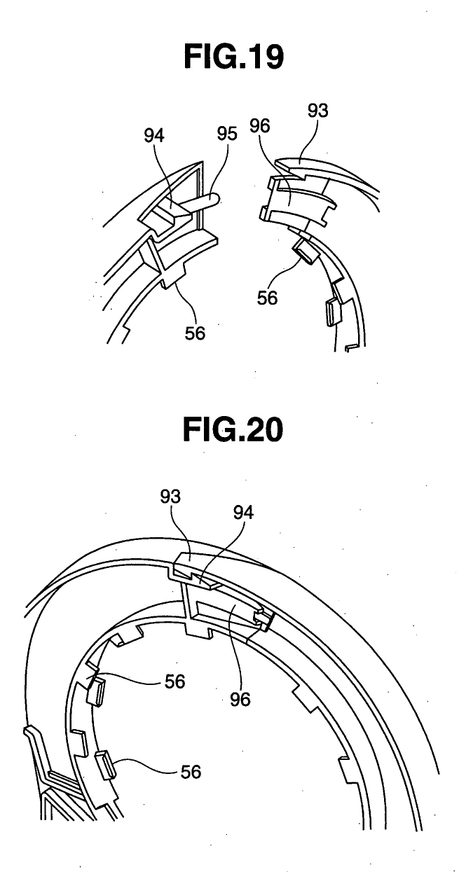

There are no particular limitations on the means for fixing the elastic member 55 to the pest-control member 7 according to the seventh embodiment; and as shown in FIGS. 15(A) and 15(B) and FIG. 16, protrusions 65 protruding toward the center of the pest-control member 7 according to the seventh embodiment can be placed at a plurality of positions on the front side and the back side as seen in the drawings (see FIGS. 19 and 20 regarding the pest-control member 7 without the elastic member 55) and the elastic member 55 can be held and secured between the protrusions 65, so that the elastic member 55 can be secured on the inside surface of the pest-control member 7.

Since the pest-control member is equipped with the elastic member 55, even if the diameter of the target, which is a migration path for pests, is different from the diameter of the target-receiving space S of the pest-control member, that difference can be filled to a certain degree. Also, even if the surface of the target is uneven, gaps between the pest-control member and the target can be closed with more certainty and pest infestation through gaps between the uneven surface of the target and the pest-control member can be prevented more reliably.

### Eighth Embodiment

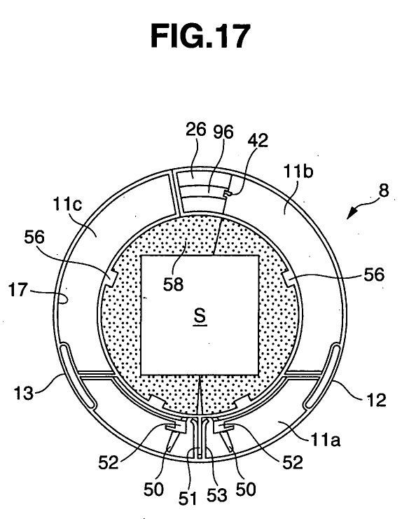

FIG. 17 shows a pest-control member 8 according to the eighth embodiment of the invention. FIG. 17 is a front view of the pest-control member 8 according to the eighth embodiment after it is attached to a target. As shown in FIG. 17, the pest-control member 8 according to the eighth embodiment is different from the pest-control member 7 according to the seventh embodiment shown in FIGS. 15(A) and 15(B) in that an elastic member 58 is formed having a quadrangular target-receiving space S.

As described above, the pest-control member can be adapted to a migration path of various cross-sectional shapes by changing the shape of the elastic member 58, which can be changed easily, without changing the shapes of the pest barrier areas 11a, 11b, and 11c. Incidentally, this embodiment has assumed as an example the case where the cross-sectional shape of the migration path is quadrangular. However, the shape of the elastic member 58 is not limited to the above example, and can be decided arbitrarily to correspond to the cross-sectional shape of a bundle of electric cords or wood or various agricultural crops.

### Ninth Embodiment

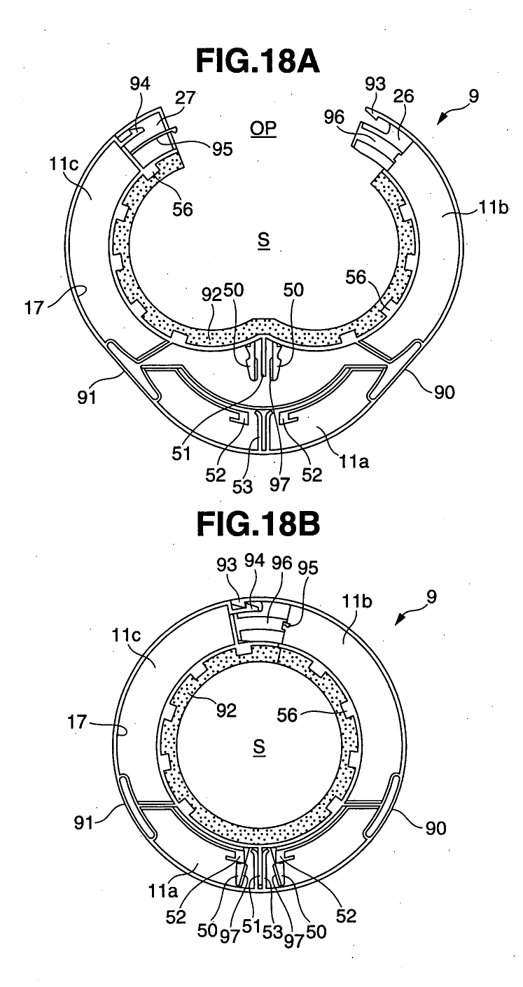

FIGS. 18(A) and 18(B) show a pest-control member 9 according to the ninth embodiment of the invention. FIGS. 18(A) and 18(B) are front views of the pest-control member 9 according to the ninth embodiment. FIG. 18A shows the pest-control member 9 according to the ninth embodiment before it is attached to a target, while FIG. 18B shows the pest-control member 9 after it is attached to the target.

As shown in FIGS. 18(A), 18(B), 19, and 20, the pest-control member 9 according to the ninth embodiment is different from the pest-control member 7 according to the seventh embodiment shown in FIGS. 15(A) and 15(B) in that a protruding strip 93 and an engaging protrusion 94 together constituting a locking mechanism are formed also at the ends of pest barrier areas 11a and 11b. Accordingly, when the pest-control member 9 according to the ninth embodiment is attached to a target (not shown in the drawings), stronger holding power can be obtained.

The pest-control member 9 is also different from the pest-control member 7 according to the seventh embodiment in that a rod protrusion 95 as a guide mechanism, and a sleeve 96 with an insertion hole (not shown) embedded therein for insertion of the rod protrusion 95 are formed at the ends of the pest barrier areas 11a and 11b. Accordingly, when the pest-control member 9 according to the ninth embodiment is attached to a target (not shown), any misalignment of the rod protrusion 95 can be corrected and the engagement between the protruding strip 93 and the engaging protrusion 94 can be performed with more certainty.

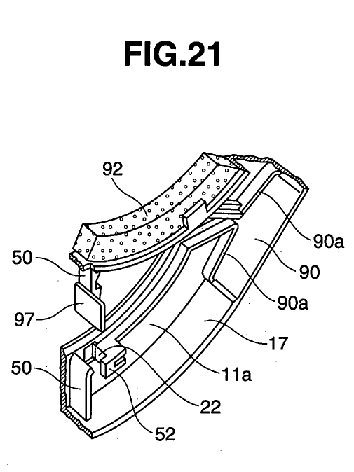

Furthermore, as shown in FIGS. 18(A), 18(B), and 21, the pest-control member 9 is also different from the pest-control member 7 according to the seventh embodiment in that release parts 97 for releasing the protruding strips 50 from the circular protrusions 22 are formed at the ends of the protruding strips 50. As a result, if the need to remove the pest-control member 9 according to the ninth embodiment from the target arises, the pest-control member 9 can be easily removed.

Furthermore, as shown in FIG. 21, the pest-control member 9 is also different from the pest-control member 7 according to the seventh embodiment in that part 90a of a wall for a hinge 90 (or 91) is formed with a height lower than that of the outside wall 17 to reduce the force applied by the hinges 90 and 91. As a result, the force of the pest barrier areas 11b and 11c trying to return to the open state is reduced. Therefore, after the pest-control member 9 is attached to a target, it is possible to prevent the engagement parts to be inserted (50, 93) from springing away from the receiving engagement parts (22, 94) due to the resilient force of an elastic member 92 against the target (not shown).

The pest-control member 9 is also different from the pest-control member 7 according to the seventh embodiment in that the elastic member 92 shown in FIGS. 18(A) and 18(B) is continuously formed along the inside surface constituting the target-receiving space S. Because the number of breaks in the elastic member is reduced, the possibility of generation of gaps through which pests may enter can be reduced.

### Tenth Embodiment

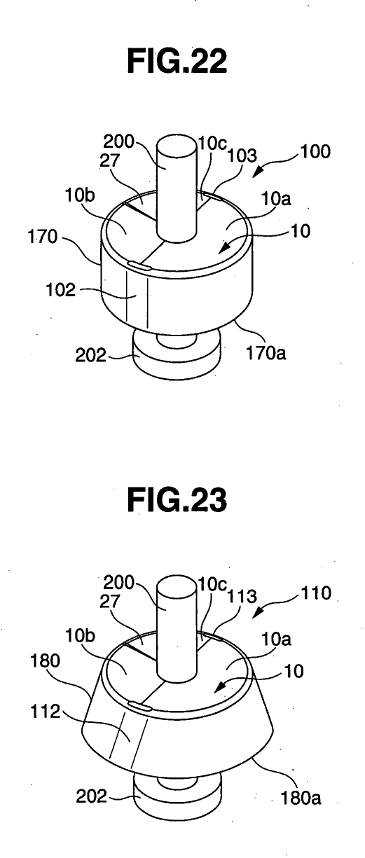

FIG. 22 shows a pest-control member 100 according to the tenth embodiment. FIG. 22 is a diagram showing the pest-control member 100 according to the tenth embodiment when it is attached to a leg 200. As shown in FIG. 22, the pest-control member 100 according to the tenth embodiment is different from the pest-control member 1 according to the first embodiment shown in FIGS. 1 to 4 in that the length of the outside wall 170 is extended. Incidentally, the thickness of the outside wall 170 is the same as that in the pest-control member 1 according to the first embodiment.

As shown in FIG. 22, the outside wall 170 of the pest-control member 100 according to the tenth embodiment extends perpendicularly (downwards in the drawing) from the outside surface of the pest barrier 10, while maintaining the diameter of its open end 170a the same as that of the base end on the pest barrier 10 side. Also, a hinge 102 for connecting the pest barrier areas 10a and 10b and a hinge 103 for connecting the pest barrier areas 10a and 10c are formed along the lengthwise direction of the outside wall 170,. The thickness of each hinge 102, 103 is thinner than that of other parts of the outside wall 170 and, like the pest-control member 1 according to the first embodiment, the hinges 102 and 103 apply force to the pest barrier areas 10b and 10c to make them open outwards.

In the pest-control member 100 having the above-described configuration, the pest barrier areas 10a, 10b, and 10c extending in a radial direction of the leg 200 become a wall to pests crawling from the base 202 and following the leg 200 to move upwards, and thereby guide the pests to turn back to where they have come from. Furthermore, the outside wall 170 becomes a downward wall (as seen in the drawings) for the pests trying to crawl over the pest barrier areas 10a, 10b, and 10c and moving upwards.(as seen in the drawing) and thereby blocks the migration of the pests.

As described above, the pest-control member 100 according to the tenth embodiment can effectively control pests by making it physically difficult for the pests to enter the equipment through the target. Also, if the pest-control member 100 is molded by using a resin containing a pest-control component, the pests can be exposed to the pest-control component for a longer period of time. Therefore, the pests can be controlled more effectively.

The outside wall 170 may be formed with the same resin used for the pest barrier 10. However, the outside wall 170 may be formed with a material capable of easily changing its shape and then attached to the pest barrier 10 in order to make it easier to open the pest barrier areas 10b and 10c.

Furthermore, the pest-control member 100 according to the tenth embodiment can be used also as a cord cover that can be attached after installment of the relevant target (specifically, a cover for a lighting ceiling hook) by making use of its shape.

### Eleventh Embodiment

FIG. 23 shows a pest-control member 110 according to the eleventh embodiment. FIG. 23 is a diagram showing the pest-control member 110 according to the eleventh embodiment when it is attached to a leg 200. As shown in FIG. 23, the pest-control member 110 according to the eleventh embodiment is different from the pest-control member 100 according to the tenth embodiment shown in FIG. 22 in that the diameter of an open end 180a of an outside wall 180 is larger than that of a base end of the outside wall 180 on the pest barrier 10 side.

In the pest-control member 110 according to the eleventh embodiment, the outside wall 180 extends from the outside surface of the pest barrier 10 at an angle of larger than 90° and smaller than 180° with the outside surface, so that the outside wall 180 is formed like a skirt spreading toward the bottom. Also, a hinge 112 for connecting the pest barrier areas 10a and 10b and a hinge 113 for connecting the pest barrier areas 10a and 10c are formed along the lengthwise direction of the outside wall 180. The thickness of each hinge 112, 113 is thinner than other parts of the outside wall 180 and, like the pest-control member 1 according to the first embodiment, the hinges 112 and 1 13 apply force to the pest barrier areas 10b and 10c to make them open outwards.

Since in the pest-control member 110 having the above-described configuration the outside wall 180 is formed in a skirt-like shape spreading toward the bottom, its effect of blocking the infestation of pests can be equal to or greater than the pest-control member 100 according to the tenth embodiment.

As described above, the design of the pest-control member according to the present invention can be changed arbitrarily in accordance with its intended use, and the pest-control member can be applied to various places. Also, the embodiments of the invention have described some pests from which the target needs to be protected, but the pest-control member according to the invention is effective for not only those pests, but also other comparatively large pests such as mice.

1. A pest-control member used to prevent equipment from pest damage by being attached to a target that becomes a migration path for pests entering the equipment, the pest-control member being configured so that it is entirely made of resin, its diameter is located perpendicular to the target when attached to the target, and it is formed in a shape to become an obstacle to the pests migrating along the target;
the pest-control member comprising:
a target-receiving space for receiving the target; and
an opening for allowing the target to be placed in the target-receiving space;
wherein when the target is placed via the opening into the target-receiving space, the pest-control member elastically changes its shape to close the opening and keeps its closed shape.

2. The pest-control member according to claim 1, wherein a locking mechanism for keeping the closed shape is provided.

3. The pest-control member according to claim 2, wherein before the target is placed in the target-receiving space, the locking mechanism is in an unlocked state and the shape of the pest-control member is maintained so that the opening connected to the target-receiving space exists; and in the process of placing the target in the target-receiving space, the pest-control member elastically changes its shape described above and the locking mechanism comes into a locked state, thereby completing the placement of the target in the target-receiving space.

4. The pest-control member according to claim 1, wherein the resin contains a pest-control compound.

5. The pest-control member according to claim 1, wherein the pest-control member is divided into a plurality of areas, the respective areas are connected via hinges to each other, the target-receiving space and the opening are formed between a first area and a second area, and the hinges elastically change their shapes to close an opening between the first area and the second area.

6. The pest-control member according to claim 2, wherein the locking mechanism is composed of a first element and a second element that engage with each other; the first element and the second element are separated from each other before the target is placed in the target-receiving space; and when the first element and the second element are moved closer to each other in the process of placing the target in the target-receiving space, and when the placement of the target in the target-receiving space is then completed, the first element and the second element engage with each other to keep the opening closed.

7. The pest-control member according to any one of claim 1, further comprising an outside wall extending radially from the outside surface of the pest-control member so that the outside wall forms an angle with the outside surface.

8. The pest-control member according to claim 7, wherein an open end of the outside wall has a diameter equal to or larger than that of a base end of the outside wall.

9. The pest-control member according to any one of claim 5, further comprising flanges extending respectively from edges of the first area and the second area that form the opening; and when the opening is closed, the flanges overlap each other tightly with no space between them in order to block pest infestation.

10. The pest-control member according to any one of claim 1, comprising a positioning protrusion for positioning the target in an area defining the target-receiving space.

11. The pest-control member according to any one of claim 6, wherein the locking mechanism further includes a release part for releasing the engagement between the first element and the second element to make them disengaged.

12. The pest-control member according to any one of claim 6, wherein the locking mechanism includes a guide mechanism for accurately guiding the first element to the second element.

13. The pest-control member according to any one of claim 1, comprising an elastic member along the inside surface of the pest-control member that constitutes the target-receiving space.

14. The pest-control member according to claim 12, wherein the elastic member contains a pest-control compound.
